(19) United States
(12) Patent Application Publication
(10) Pub. No.: US 2004/0260927 A1
(43) Pub. Date: Dec. 23, 2004

(54) Remote data storage validation

(76) Inventor: Steven L. Grobman, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/600,124

(22) Filed: Jun. 20, 2003

(51) Int. Cl. H04L 9/00

(52) U.S. Cl. 713/172

(57) ABSTRACT

A first key is generated, and first validity data is generated based on first backup data and the first key. The first key is sent to a peer storing the first backup data. Second validity data is requested from the peer to determine whether the first backup data is preserved by the peer. The second validity data is based on the first backup data stored by the peer and the first key.

### TECHNICAL FIELD

This disclosure relates generally to data storage, and more particularly to remote data storage validation.

### BACKGROUND INFORMATION

Current backup systems for personal and small-office users typically rely on secondary on-site storage of data. Although these on-site backups provide data redundancy, they are vulnerable to localized catastrophe. More sophisticated off-site backups are possible, but are usually expensive, difficult to manage, and are still a centralized form of redundancy. Recently, peer-to-peer backup systems have been used to provide users with the ability to backup files and restore files from a distributed network of peers.

In current peer-to-peer backup systems, users may form partnerships for data storage. In a typical partnership, a user is able to store their data on a partner's system for backup purposes, in return for a user storing the partner's data. However, in current peer-to-peer backup systems, one partner may destroy the other partner's data, as each partner has physical control over their own hardware. Current peer-to-peer backup systems have the disadvantage that partners lack incentives for preserving a user's data. Another disadvantage of current peer-to-peer backup systems is that users lack adequate means for determining whether a partner is fulfilling their backup obligations.

### DESCRIPTION OF THE DRAWINGS

FIG. 1 is a block diagram of one embodiment of a peer-to-peer backup system.

FIG. 2 illustrates an embodiment of a network suitable for practicing the present invention.

FIG. 3 illustrates an embodiment of a network suitable for practicing the present invention.

FIG. 4 illustrates an embodiment of a computer system suitable for use in practicing the present invention.

FIG. 5A illustrates a flow chart of an embodiment of an audit method.

FIG. 5B illustrates a flow chart of an embodiment of a validity data generation method.

FIG. 6 illustrates a flow chart of an embodiment of an audit method.

### DETAILED DESCRIPTION

In the following detailed description of embodiments of the invention, reference is made to the accompanying drawings in which like references indicate similar elements, and in which, by way of illustration, specific embodiments in which the invention may be practiced are shown. These embodiments are described in sufficient detail to enable those skilled in the art to practice the invention, and it is to be understood that other embodiments may be utilized and that logical, mechanical, electrical, functional and other changes may be made without departing from the scope of the present invention. The following detailed description is, therefore, not to be taken in a limiting sense, and the scope of the present invention is defined only by the appended claims.

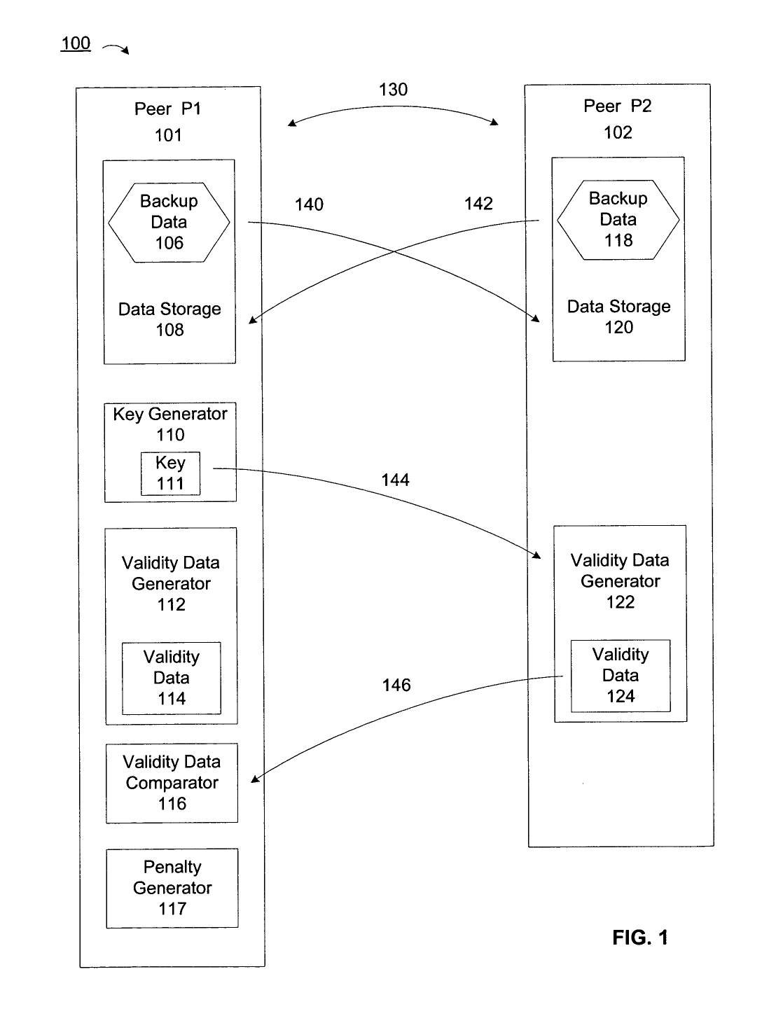

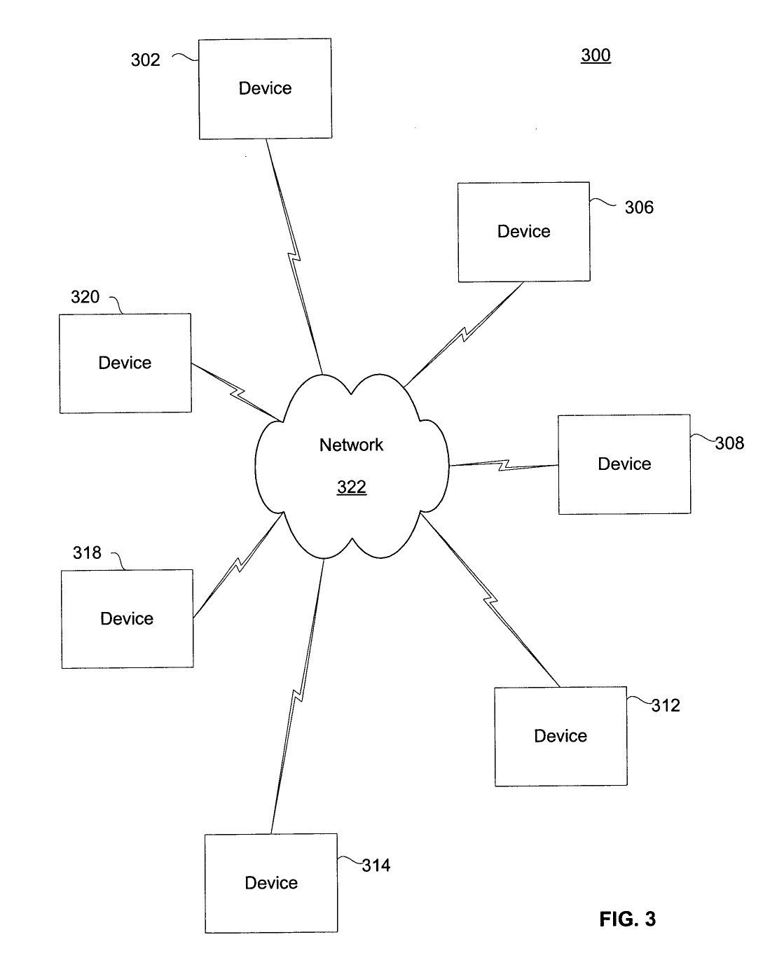

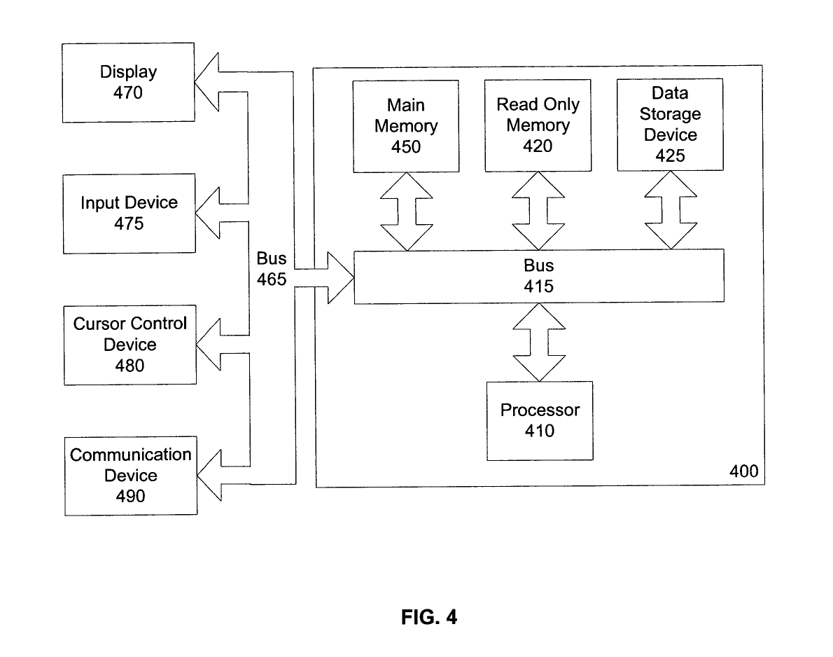

A system level overview of the operation of an embodiment of the invention is described with reference to FIG. 1. An embodiment of a peer-to-peer backup system 100 is described. Backup system 100 includes peer 101 (P1), and peer 102 (P2), backup data 106, 118, data storage 108, 120, key generator 110, key 111, validity data generators 112, 122, validity data storage 114, validity data comparator 116, and penalty generator 117. In one embodiment, each peer P1, P2 serves as a client, a server, or both, as described below in conjunction with FIG. 3. In one embodiment, peers P1 and P2 are any of a personal computer, a handheld computer, or other computing device, as described below in conjunction with FIG. 4. In one embodiment, P1 and P2 each represent a different user of a network.

Backup data 106 and 118 may be any digital information which is capable of being stored on P1 and P2, respectively. In one embodiment, backup data 106, 118 are any data that is valuable and should be stored off-site. In one embodiment, backup data 106, 118 are encrypted. Data storage 108, 120 includes memory, such as a nonvolatile memory. In one embodiment, backup data 106 and 118 are stored in data storage 108, 120, respectively. In one embodiment, data storage 108, 120 includes a hard disk drive.

In one embodiment, the key generator 110 generates a key 111. In one embodiment, a key 111 is a string of ASCII (American Standard Code for Information Interchange) characters. In one embodiment, key 111 is a string of binary digits. In one embodiment, the key generator 110 randomly generates a key 111.

Validity data generators 112, 122 generate validity data 114 and validity data 124, respectively, based on backup data 106 and a key 111. In one embodiment, backup data 106 and key 111 are combined, then validity data 114 is generated from the combination. In one embodiment, backup data 106 is encrypted using key 111, and validity data 114 is generated from the encrypted backup data. It will be appreciated that other combinations of the backup data and the key may be used to generate validity data.

In one embodiment, validity data 114, 124 are hash values generated by using a one-way hash function. Examples of one-way hash functions include compression functions, contraction functions, message digests, fingerprints, cryptographic checksums, data integrity checks (DIC), manipulation detection codes (MDC), method message authentication codes (MAC), and data authentication codes (DAC), among others. Specific examples of one-way hash functions include Message Digest 5 (MD5), MD2, MD4, Secure Hash Algorithm-1 (SHA-1), SHA-2 (SHA-256, SHA-384, SHA-512), RACE Integrity Primitives Evaluation Message Digest (RIPEMD), RIPEMD-128, RIPEMD-160, Panama, Tiger, N-Hash, and HAVAL.

A hash function is a function that takes an input string and converts it to a fixed size (often smaller) output string. A one-way hash function is a hash function that is also a one-way function: it is easy to compute a hash value from an input string, but it is extremely difficult to generate a string that hashes to a particular value. Additionally, the output of a one-way hash function is not dependent on the input string in any discernable way. A single bit change in the input string changes, on the average, half of the bits in the hash value. For example, a one-way hash function, H(i), operates on an arbitrary length input string, i, to return a fixed-length hash value, v. The input string i may also be referred to as a pre-image, bit sequence, or message, among others. In general, one-way hash functions have the following characteristics that make them one-way:

Given i, it is easy to compute v.

Given v, it is hard to compute i, such that H(i)=v.

Given i, it is hard to find another input string, i′, such that H(i)=H(i′).

For example, the MD5 one-way hash function returns hash values on the order of 128 bits long, so that there are 2¹²⁸ possible hash values. The number of trials required to find a random string with the same hash value as a given string is 2¹²⁸, and the number of trials required to find two random strings having the same (random) hash value is 2⁶⁴.

In one embodiment, validity data 114, 124 is a fixed size output string derived from the backup data 106 and the key 111. In one embodiment, the size of the validity data 114, 124 is selected so that sending validity data 124 does not overburden network resources.

The use of a one-way hash function makes it extremely difficult to derive the backup data 106 and the key 111 from the validity data. In one embodiment, an MD5 function is used to generated the validity data 114, 124. In one embodiment, a SHA-1 function is used to generated the validity data 114, 124. Validity data comparator 116 compares validity data 114 with validity data 124 and determines whether they match. In one embodiment, validity data comparator 116 determines if the validity data are identical. Penalty generator 117 inflicts penalties against P2.

Processes performed within backup system 100 are illustrated in FIG. 1 through arrows 130, 140, 142, 144, and 146. In one embodiment, P1 and P2 negotiate a partnership for data storage (arrow 130). In one embodiment, P2 stores backup data 106 for P1 in data storage 120, in exchange for P1 storing backup data 118 for P2 in data storage 108. In one embodiment, the data storage partnership may be the result of an electronic agreement or contract between P1 and P2. In one embodiment, P2 stores backup data 106 for P1 in exchange for consideration provided by P1. In one embodiment, the consideration is a periodic payment for storage.

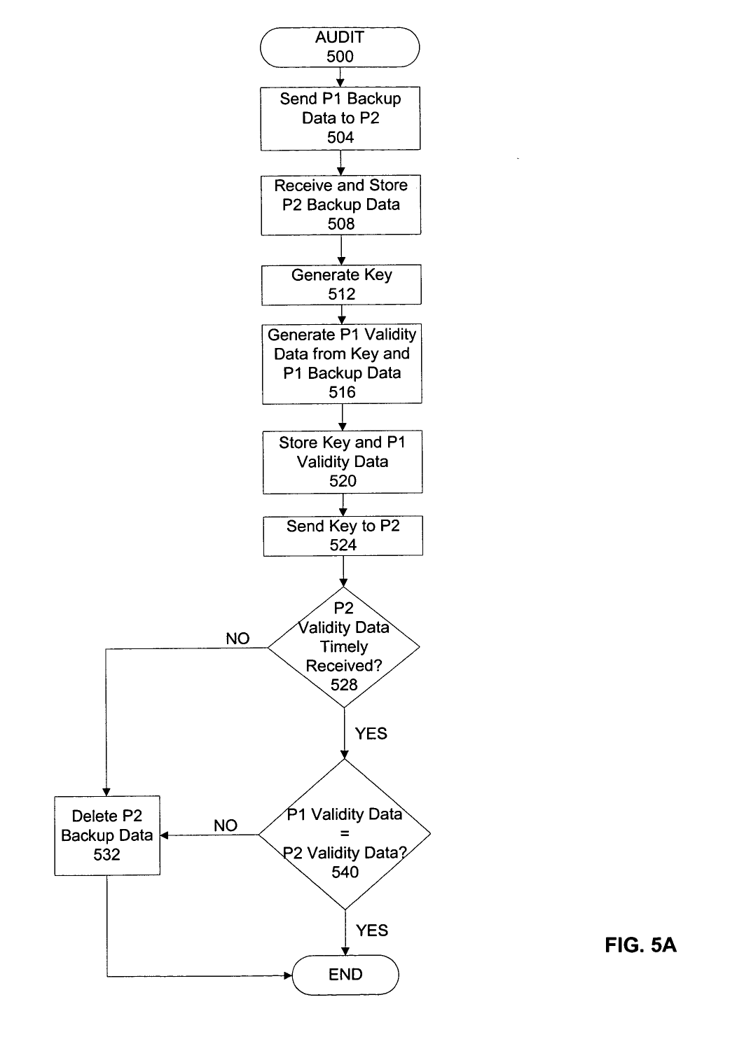

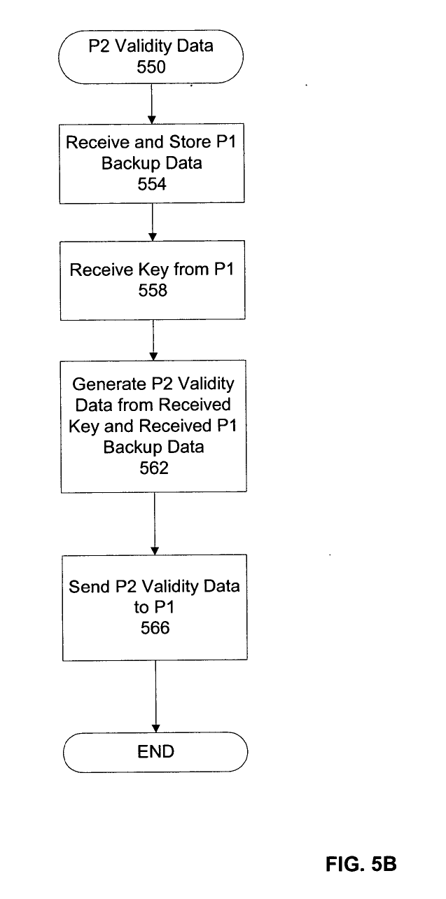

In one embodiment, P1 receives backup data 118 from P2 (arrow 142), and P2 receives backup data 106 from P1 (arrow 140). Typically, backup data 106 is not needed by P1 unless a data recovery is necessary. However, it is important that P1 be assured that P2 has not discarded, deleted, or otherwise corrupted backup data 106. To ensure that P2 is preserving backup data 106, P1 may initiate an audit or challenge to P2, as described below with respect to FIG. 5A.

A key 111 is generated by key generator 110. Validity data generator 112 generates validity data 114 based on the backup data 106 and the key 111. In one embodiment, validity data 114 can only be created if validity data generator 112 has access to the entire backup data image 106. In one embodiment, validity data 114 is the result of the one-way hash of the combined key and the backup data 106. P1 sends the key 111 to P2 (arrow 144). P2 receives the key 111, and validity data generator 122 generates validity data 124 based on key 111 and the backup data 106 stored by P2 in data storage 120. P2 sends validity data 124 to P1 (arrow 146). P1 receives validity data 124 from P2 (arrow 146), and validity data comparator 116 compares validity data 114 with validity data 124. In one embodiment, the validity data comparator determines whether validity data 114 is the same as validity data 124. In one embodiment, the parallel operation takes place to permit P2 to validate its backup data 118 stored by P1 in data storage 108.

In one embodiment, if validity data 114 and validity data 124 are different or not matching, P2 is penalized by penalty generator 117. For example, in one embodiment, if validity data 114 and validity data 124 are different, penalty generator 117 penalizes P2 by discarding backup data 118 from data storage 108. Penalty generator may also inflict other penalties against P2, as described below.

In one embodiment, P2 agrees to store backup data 106 for P1 in exchange for consideration, such as a monetary fee. In such an embodiment, P1 may not necessarily store backup data 118 for P2. In one embodiment, if validity data 114 and validity data 124 are different, P1 is entitled to compensation from P2. In one embodiment, such compensation may be recovering at least a portion or all of consideration given by P1 to P2 for storing backup data 106.

It will be appreciated that backup data 106 may be any type of data, and should not be construed as being limited only to data which is stored for recovery purposes. For example, in one embodiment, if a company wanted to ensure that every computer on its network has a current version of a procedure manual (stored as a digital file), a similar scheme as described above could be used even though the intent is not to “backup” the manual, but instead to verify possession of a current version of the manual.

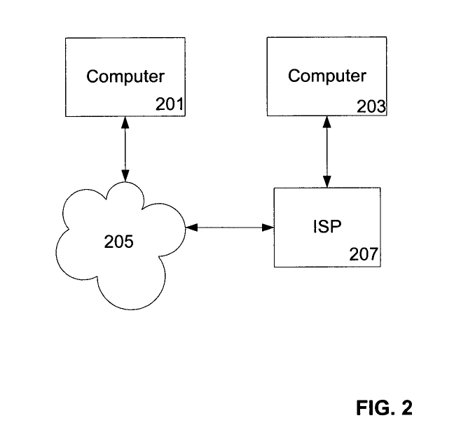

In one embodiment, as shown in FIG. 2, a computer 201 is part of, or coupled to a network 205, such as the Internet, to exchange data with another computer 203, as either a client or a server computer. For example, in one embodiment, peer P1 of FIG. 1 is a computer 201 and is part of, or coupled to a network 205 to exchange data with other computers 203. Typically, a computer is coupled to the Internet through an ISP (Internet Service Provider) 207 and uses a conventional Internet browsing application to exchange data with a server. Other types of applications allow clients to exchange data through the network 205 without using a server. It is readily apparent that the present invention is not limited to use with the Internet; directly coupled and private networks are also contemplated.

For instance, in one embodiment, peer P1 and peer P2 of FIG. 1 are computers coupled together in a peer-to-peer network such as illustrated in FIG. 3. FIG. 3 illustrates one embodiment of a peer-to-peer network environment 300 that is layered on top of a standard network 322, such as a Wide-Area Network (WAN) or a Local-Area Network (LAN). Each device node connected to the network 322 may be logically coupled through the network 322 to any of the other nodes on the network 322 to form peer-to-peer network environment 300. Each node may correspond to one or more physical devices. As illustrated, peer-to-peer network environment 300 includes device 302, device 306, device 308, device 312, device 314, device 318, and device 320.

Each device is at least capable of performing peer-to-peer communications with the other devices functioning as peers in the network environment 300. Peer-to-peer communications includes the sharing of computer resources and services by direct exchange between peer devices (or indirectly though an intermediate peer device). These resources and services may include the exchange of information, processing cycles, cache storage, and disk storage for files, among other examples, although all of the resources and services are not required to be present on each peer device. Therefore, each device 302, 306, 308, 312, 314, 318, and 320 in the network 300 may initiate a peer-to-peer communications session in the network environment 300.

Each device also has the capability of identifying devices it would like to communicate or initiate a relationship with, to discover devices entering and leaving the network environment 300 (discovery process), and to determine what communications protocol is being used in the network environment 300. For example, communication between peer devices may be via a wire and/or wireless protocol, such as TCP/IP (Transmission Control Protocol/Internet Protocol), Real Time Streaming Protocol (RTSP), Bluetooth, 802.11x protocols commonly referred to as WiFi (Wireless Fidelity), and WAP (Wireless Application Protocol) used to exchange data across mobile telephone networks, among other communication protocols well known in the art.

The devices 302, 306, 308, 312, 314, 318, and 320 may include typical devices, such as a desktop computer, a home entertainment system, a set-top box, a gaming system, among other examples. Alternatively, the devices 302, 306, 308, 312, 314, 318, and 320 may include mobile devices such as a personal digital assistant (PDA), a mobile phone, a portable computer, a pager, a portable music player (e.g., an MPEG Audio Layer 3 player), among other devices. An embodiment of a suitable device is described below in conjunction with FIG. 4.

It will be appreciated that the peer-to-peer network environment 300 illustrated in FIG. 3 does not limit the configuration of peer-to-peer networks in which the backup system 100 may be employed. For example, one of skill in the art will readily appreciate that a server may be coupled to peer-to-peer network to provide centralized services to peer devices. Furthermore, one of skill in the art will immediately understand that more than one peer-to-peer network environment may be layered on the same underlying network structure and that each peer device may participate in multiple peer-to-peer network environments simultaneously.

FIG. 4 illustrates an embodiment of a computer system that may be used with the present invention. It will be apparent to those of ordinary skill in the art, however that other alternative systems of various system architectures may also be used.

The data processing system illustrated in FIG. 4 includes a bus or other internal communication means 415 for communicating information, and a processor 410 coupled to the bus 415 for processing information. The system further comprises a random access memory (RAM) or other volatile storage device 450 (referred to as memory), coupled to bus 415 for storing information and instructions to be executed by processor 410. Main memory 450 also may be used for storing temporary variables or other intermediate information during execution of instructions by processor 410. The system also comprises a read only memory (ROM) and/or static storage device 420 coupled to bus 415 for storing static information and instructions for processor 410, and a data storage device 425 such as a magnetic disk or optical disk and its corresponding disk drive. Data storage device 425 is coupled to bus 415 for storing information and instructions.

The system may further be coupled to a display device 470, such as a cathode ray tube (CRT) or a liquid crystal display (LCD) coupled to bus 415 through bus 465 for displaying information to a computer user. An alphanumeric input device 475, including alphanumeric and other keys, may also be coupled to bus 415 through bus 465 for communicating information and command selections to processor 410. An additional user input device is cursor control device 480, such as a mouse, a trackball, stylus, or cursor direction keys coupled to bus 415 through bus 465 for communicating direction information and command selections to processor 410, and for controlling cursor movement on display device 470.

Another device, which may optionally be coupled to computer system 400, is a communication device 490 for accessing other nodes of a distributed system via a network. The communication device 490 may include any of a number of commercially available networking peripheral devices such as those used for coupling to an Ethernet, token ring, Internet, or wide area network. The communication device 490 may further be a null-modem connection, a wireless connection mechanism, or any other mechanism that provides connectivity between the computer system 400 and the outside world. For example, the communication device 490 may include coaxial cable, fiber-optic cable or twisted pair cable. Note that any or all of the components of this system illustrated in FIG. 4 and associated hardware may be used in various embodiments of the present invention.

It will be appreciated by those of ordinary skill in the art that any configuration of the system may be used for various purposes according to the particular implementation. The control logic or software implementing the present invention can be stored in main memory 450, data storage device 425, or any machine-accessible medium locally or remotely accessible to processor 410. A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.).

It will be apparent to those of ordinary skill in the art that the system, method, and process described herein can be implemented as software stored in main memory 450 or read only memory 420 and executed by processor 410. This control logic or software may also be resident on an article of manufacture comprising a computer readable medium having computer readable program code embodied therein and being readable by the data storage device 425 and for causing the processor 410 to operate in accordance with the methods and teachings herein.

The present invention may also be embodied in a handheld or portable device containing a subset of the computer hardware components described above. For example, the handheld device may be configured to contain only the bus 415, the processor 410, and memory 450 and/or 420. The present invention may also be embodied in a special purpose appliance including a subset of the computer hardware components described above. For example, the appliance may include a processor 410, a data storage device 425, a bus 415, and memory 450, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

The description of FIGS. 2-4 is intended to provide an overview of computer hardware and various operating environments suitable for implementing embodiments of the invention, but is not intended to limit the applicable environments. It will be appreciated that the system 400 is one example of many possible devices that have different architectures. A typical device will usually include at least a processor, memory, and a bus coupling the memory to the processor. Such a configuration encompasses personal computer systems, network computers, television based systems, such as Web TVs or set-top boxes, handheld devices, such as cell phones, portable media devices, personal digital assistants, and similar devices. One of skill in the art will immediately appreciate that embodiments of the invention can be practiced with other system configurations, including multiprocessor systems, minicomputers, mainframe computers, and the like. Embodiments of the invention can also be practiced in distributed computing environments where tasks are performed by remote processing devices that are linked through a communications network.

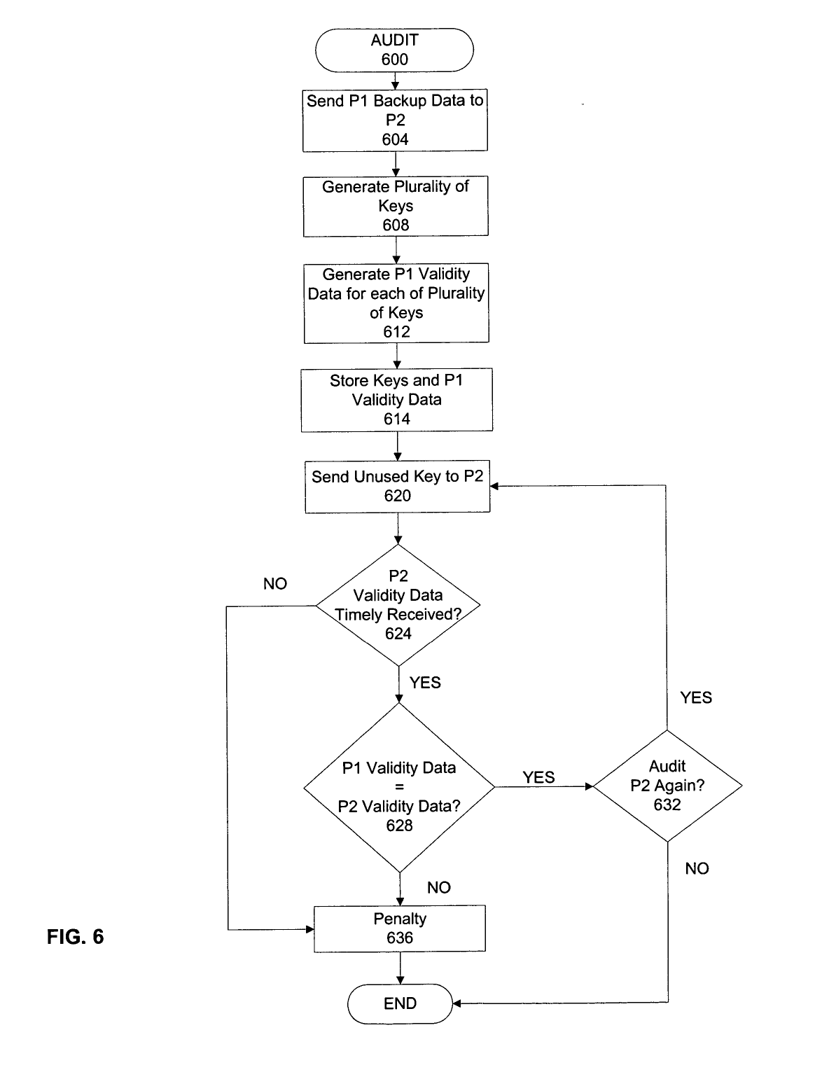

The particular methods of embodiments of the invention are described in terms of computer software with reference to a series of flow charts. FIG. 5A illustrates a flow chart of one embodiment of an audit method 500. FIG. 5B illustrates an embodiment of a method 550 of generating validity data. FIG. 6 illustrates a flow chart of one embodiment of an audit method 600.

The methods 500, 550 and 600 constitute computer programs made up of computer-executable instructions illustrated as blocks (acts) in FIGS. 5A, 5B and 6. Describing the methods by reference to a flow chart enables one skilled in the art to develop such programs including such instructions to carry out the methods on suitably configured computers. The computer-executable instructions may be written in a computer programming language or may be embodied in firmware logic. If written in a programming language conforming to a recognized standard, such instructions can be executed on a variety of hardware platforms and for interface to a variety of operating systems. In addition, the present invention is not described with reference to any particular programming language. It will be appreciated that a variety of programming languages may be used to implement embodiments of the invention as described herein. Furthermore, it is common in the art to speak of software, in one form or another (e.g., program, procedure, process, application, module, logic, etc.), as taking an action or causing a result. Such expressions are merely a shorthand way of saying that execution of the software by a computer causes the processor of the computer to perform an action or produce a result. It will be appreciated that embodiments including more or fewer processes may be incorporated into the methods illustrated in FIGS. 5A, 5B and 6 without departing from the scope of the invention and that no particular order is implied by the arrangement of blocks shown and described herein.

Referring to FIG. 5A, an embodiment of the acts to be performed by a processor executing the audit method 500 are shown. For simplicity, an embodiment of an audit or challenge method initiated by P1 is described. It will be appreciated that in one embodiment, an audit may be initiated by P2 where P1 stores P2's backup data. In one embodiment, P1 randomly initiates an audit of P2. In one embodiment, the audit, or challenge, is performed to determine whether P2 is fulfilling its storage obligations. In one embodiment, P1 initiates an audit of P2 periodically. In one embodiment, P1 is able to audit P2 when P2 is available through the network.

At block 504, P1 sends P1 backup data to P2. In one embodiment, the P1 backup data is encrypted. In one embodiment, the P1 backup data is encrypted so that the source data is protected from being obtained by P2. Typically, backup data is stored on different storage media, such as storage media at P2, for recovery purposes. For example, P1 may need to recover the P1 backup data as the result of a hard drive crash, a virus, or other events which destroy or otherwise compromise data integrity. In one embodiment, P1 sends the P1 backup data to multiple peers, to reduce the risk of data loss.

At block 508, P1 receives and stores the P2 backup data. In one embodiment, P1 and P2 have a relationship in which each agrees to store the other's backup data. In another embodiment, no formal relationship exists between P1 and P2. At block 512, P1 generates a key. In one embodiment, the key is randomly generated. In one embodiment, more than one key is generated. In one embodiment, the size of the key is selected so that the audit method 500 does not overburden network resources. In one embodiment, the size of the key is selected so that the key is cryptographically secure. For example, in one embodiment, a key is 128-bits. In one embodiment, a key is 160-bits.

At block 516, P1 generates P1 validity data based on the key and the P1 backup data. In one embodiment, the key is combined with the P1 backup data to create keyed P1 backup data. The key and the P1 backup data may be combined in various manners. For example, the key may be concatenated, appended, or prepended to the P1 backup data to create keyed P1 backup data. In one embodiment, the key is inserted at arbitrary locations within the P1 backup data. In one embodiment, the keyed P1 backup data is encrypted. In one embodiment, the P1 validity data is generated from the keyed P1 backup data. The P1 validity data may be generated using an algorithm that turns the keyed P1 backup data into a fixed-length string. For example, in one embodiment, the P1 validity data is a fixed-length hash value. In one embodiment, the length of the P1 validity data is small, such as 128-bits, regardless of the size of the keyed P1 backup data from which the P1 validity data was generated. For example, in one embodiment, 1 kilobyte of keyed P1 backup data and 1 gigabyte of keyed P1 backup data will each produce P1 validity data of the same size, such as 128-bits, when generated using the same algorithm. It will be appreciated that other lengths of the P1 validity data are possible, such as for example, 160-bits, or 256-bits.

In one embodiment, the P1 validity data is generated through an algorithm which is designed so that a difference of even only one bit between keyed P1 backup data will result in a different P1 validity data value. Thus, in one embodiment, each different combination of a different key and the P1 backup data will be very likely to yield unique P1 validity data. In one embodiment, the P1 validity data is generated by performing a hash function on the keyed P1 backup data. Suitable algorithms for generating P1 validity data, such as MD5, are discussed above with respect to FIG. 1. In one embodiment, the P1 validity data is generated by performing a one-way hash function on the keyed P1 backup data. For example, in one embodiment, an MD5 or SHA-1 function may be performed on the keyed P1 backup data to generate the P1 validity data. In one embodiment, the validity data is encrypted.

At block 520, P1 stores the key and the P1 validity data. In another embodiment, P1 does not store the key and P1 validity data, for example, where P1 immediately receives a response from P2. At block 524, the P1 sends the key to P2, and thus initiates an audit of P2. In one embodiment, sending the key to P2 is a request for P2 to generate and send validity data to P1, to prove that P2 still possesses the P1 backup data. In one embodiment, an audit request is sent with a key to P2. In one embodiment, where multiple keys are generated, P1 selects one of the keys and sends the selected key to P2. In one embodiment, the key is small in size, such as 128-bits or similar, so that the process of sending the key to P2 does not overburden network resources. In one embodiment, the key size is selected to be cryptographically strong.

At decision block 528, P1 determines whether the requested validity data has been timely received from P2. Receiving validity data from P2 in a timely manner is important in a backup system for several reasons. For example, if P2 does not appear on a network for an extended period of time, it is difficult for P1 to readily determine whether the P1 backup data is still being stored by P2. In addition, an extended absence from the network makes it difficult for P1 to access the P1 backup data for recovery purposes. In other words, the disappearance of P2 from the network for an extended period of time jeopardizes P1's ability to effectively preserve the P1 backup data.

The amount of time that may pass before a response is not considered timely depends on the specific implementation. For example, in one embodiment, in a corporate desktop environment, a response is considered timely if it is received from P2 within one week after the key was sent to P2. In one embodiment, a response from a P2 is timely if validity data is received within three days after P1 has requested validity data. For example, where P1 employs a mobile device, greater or lesser response times may be considered timely. Shorter or longer periods may be considered timely depending on the implementation of the present invention. For example, in one embodiment, a response is considered timely if the requested validity data is received within one day. In one embodiment, the period of time for a timely response is related to the frequency with which the original data changes.

In one embodiment, if validity data is not timely received from P2, P2 is penalized. In one embodiment, if a timely response is not received from P2, P1 is relieved of any obligations to P2 (e.g. storage of P2 backup data, periodic payment). In one embodiment, if a timely response is not received from P2, P1 deletes P2 backup data at block 532. Thus, P2 may be more inclined to have P1 backup data available due to the threat of having the P2 backup data being deleted in response to an extended absence from the network. Other penalties may occur in place of, or in addition to deleting P2's backup data from P1. For example, in one embodiment, if a timely response is not received from P2, P2 is sent a warning that P2 backup data stored by P1 will be deleted if a response is not received after a predetermined time. In one embodiment, P1 is entitled to monetary or other compensation as a penalty for not receiving a timely response from P2. In one embodiment, if a timely response is not received from P2, P1 breaks a storage relationship with P2 and initiates a new storage relationship with another peer.

In one embodiment, P2 validity data is generated by P2 according to a P2 validity data method 550, described with respect to FIG. 5B. Referring now to FIG. 5B, an embodiment of a P2 validity data method 550 is described. At block 554, P2 receives and stores P1 backup data. At block 558, P2 receives a key from P1. At block 562, P2 generates validity data from the received key and the stored P1 backup data. In one embodiment, P2 generates P2 validity data according to the identical procedure or algorithm by which P1 generates P1 validity data. At block 566, P2 sends P2 validity data to P1.

Referring again to FIG. 5A, where P1 timely receives P2 validity data at block 528, P1 determines whether P1 validity data is equal to P2 validity data at block 540. In one embodiment, block 540 is performed by the validity data comparator 116 of FIG. 1. In one embodiment, where P1 determines at block 540 that P1 validity data and P2 validity data are different, P2 backup data is deleted at block 532. The threat of having P2's backup data deleted provides an incentive for P2 not to delete P1's backup data. In one embodiment, if P1 validity data and P2 validity data are determined to be different, other penalties may occur in place of, or in addition to the deletion of P2 backup data, as discussed above. In one embodiment, where P1 validity data and P2 validity data are determined to be the same at block 540, the method 500 ends. When P1 validity data and P2 validity data are equal, P1 may be assured that P2 has preserved the P1 backup and that P1 backup data is not corrupted, at least as of the time the P2 validity data was generated.

It will be appreciated that other means of verifying that P2 possesses the P1 backup data are possible. For example, in one embodiment, the P2 validity data and P1 validity data are not identical, but instead are corresponding or matching pairs of data. In such an embodiment, P2 is only capable of providing matching P2 validity data if P2 has preserved the P1 backup data and possesses the selected key. For example, in one embodiment, rather than determining if the P1 validity data and the P2 validity data are identical, P1 determines whether the P2 validity data and the P1 validity data form a matching pair.

In one embodiment, instead of comparing P1 validity data to P2 validity data to determine if they are the same, P1 may compare only a specific portion of the P1 validity data with the P2 validity data. For example, in one embodiment, after generating P1 validity data 128-bits in length, P1 compares only the last 32 bits of the P1 validity data to the last 32 bits of the received P2 validity data. In one embodiment, P1 only stores a specific portion of the P1 validity data, and compares that specific portion to the corresponding portion of received P2 validity data. By employing a truncated match, P1 may save local storage space by having to store only a portion of P1 validity data for comparison to P2 validity data.

Referring now to FIG. 6, an embodiment of an audit method 600 is described. At block 604, P1 sends the P1 backup data to P2 for storage. In one embodiment, the P1 backup data is encrypted.

At block 608, P1 generates a plurality of keys. In one embodiment, the keys are randomly generated. The number of keys to be pre-generated depends on the specific implementation of the present invention. In one embodiment, the number of keys generated is dependent on the frequency with which the source data of the backup data changes. For example, in an implementation that asserts preservation or existence of P1 backup data daily, sufficient keys may be generated so that an audit may be made once an hour. In one embodiment, in an implementation where the P1 backup data is refreshed every two weeks, at least 14 keys are generated so that an audit may be made at least once daily before the P1 backup data is refreshed. In one embodiment, P1 generates at least fifty unique keys. In one embodiment, since the keys and validity data are relatively small, for example, 128-bits each, it is practical to generate more keys and respective validity data than are expected to be used.

At block 612, P1 generates P1 validity data based on P1 backup data and each of the plurality of keys. In one embodiment, separate P1 validity data is generated based on each key and the P1 backup data. For example, in one embodiment, if thirty keys are generated, then thirty distinct P1 validity data will be generated (i.e. one unique P1 validity data for each key and P1 backup data combination). In one embodiment, P1 validity data is generated from keyed P1 backup data. By generating a plurality of validity data based on a plurality of keys and the P1 backup data, P1 may continue to audit P2 to determine if P2 still possesses P1 backup data, regardless of whether P1 possesses a copy of the P1 backup data. Thus, in one embodiment, P1 discards P1 backup data (e.g. to save local storage space) after generating validity data for each of the plurality of keys, and yet may still effectively determine whether P2 stores a copy of the P1 backup data.

At block 614, P1 stores the plurality of keys and the corresponding P1 validity data. In one embodiment, each of the plurality of keys is associated with its corresponding P1 validity data which was derived from the specific key and the P1 backup data, to facilitate any audit or challenges. At block 620, P1 sends one of the plurality of keys to P2. In one embodiment, only keys which have not previously been sent to P2 are sent to P2 (i.e. unused keys). Sending a key to P2 is a request that P2 generate P2 validity data from the sent key and the P1 backup data stored by P2, and that P2 send the P2 validity data to P1. In one embodiment, P2 validity data is generated by P2 as described above with respect to FIG. 5B.

At block 624, P1 determines whether the requested P2 validity data has been timely received from P2. In one embodiment, if a timely response is not received from P2, P1 penalizes P2 at block 636. The penalty against P2 may include deletion of P2 backup data stored by P1, or the return of consideration given to P2, among others, as discussed above.

If P2 validity data is timely received at block 624, P1 determines at block 628 whether the P1 validity data for the selected key is the same as the received P2 validity data at block 628. Where P1 determines at block 628 that the P1 validity data and the P2 validity data are different, a penalty is triggered at block 636.

In one embodiment, where the P1 validity data and the P2 validity data are determined to be the same at block 628, a determination is made at block 632 whether to audit P2 again. If a determination is made to audit P2 again, the process returns to block 620, and an unused key is sent to P2. In one embodiment, P1 repeatedly verifies that P2 stores the P1 backup data by sending unused keys to P2 and comparing the P2 validity data to the P1 validity data for each respective key. In one embodiment, if P1 determines not to audit P2 again, the method ends.

In one embodiment, P1 may audit P2 according to the methods described above with respect to FIGS. 5A, 5B and 6, as part of a recovery scenario. In such an embodiment, P1 uses pre-generated keys and associated validity data to determine whether the P1 backup data stored by P2 is uncorrupted or unaltered, prior to recovery. This may be helpful in a situation where P1 has stored the P1 backup data on several peers. In one embodiment, P1 can verify the integrity of the backup data stored on each of the peers, even if P1 no longer has the backup data.

In one embodiment, P1 stores backup data for a different peer than a peer who validates storage of P1 backup data. For example, in one embodiment, P2 stores P1 backup data, P3 stores P2 backup data, and P1 stores P3 backup data. P1 may audit P2, P2 may audit P3 and P3 may audit P1.

It will be appreciated that embodiments of the present invention may be employed in non peer-to-peer environments. For example, in one embodiment, P1 stores the P1 backup data on a central server, and P1 may audit or challenge whether the central server still possesses the P1 backup data in a similar manner to those described above. Furthermore, it will be appreciated that embodiments of the present invention may be incorporated into a protocol for peer-to-peer data storage.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The above description of illustrated embodiments of the invention, including what is described in the Abstract, is not intended to be exhaustive or to limit the invention to the precise forms or embodiments disclosed. While specific embodiments of, and examples for, the invention are described herein for illustrative purposes, various equivalent modifications are possible within the scope of the invention, as those skilled in the relevant art will recognize. These modifications can be made to embodiments of the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method comprising:
generating a first key;
generating first validity data based on first backup data and the first key;
sending the first key to a peer storing the first backup data; and
requesting second validity data from the peer to determine whether the first backup data is preserved by the peer, wherein the second validity data is based on the first backup data stored by the peer and the first key.

2. The method of claim 1, further comprising:
penalizing the peer if the second validity data is not timely received from the peer.

3. The method of claim 2, further comprising:
receiving the second validity data from the peer;
determining whether the first validity data and the second validity data are different; and
penalizing the peer if the first validity data and the second validity data are determined to be different.

4. The method of claim 3, further comprising:
storing second backup data received from the peer, wherein penalizing the peer comprises deleting the second backup data.

5. The method of claim 3, further comprising:
providing the peer with consideration for storing first backup data, wherein penalizing the peer comprises recovering at least a portion of the consideration.

6. The method of claim 1, wherein the first backup data is encrypted.

7. The method of claim 1, wherein generating first validity data comprises:
combining the first key and the first backup data to create first keyed backup data; and
performing a one-way hash function on the first keyed backup data.

8. The method of claim 7, wherein the one-way hash function is selected from the group consisting of MD5, SHA-1, and RIPEMD-160.

9. The method of claim 1, further comprising:
generating a plurality of additional keys;
generating additional validity data for each of the additional keys, wherein each additional validity data is based on the first backup data and one of the additional keys;
sending a selected one of the additional keys to the peer; and
requesting third validity data from the peer to determine whether the first backup data is preserved by the peer, wherein the third validity data is based on the first backup data stored by the peer and the selected one of additional keys.

10. The method of claim 9, further comprising:
storing the additional validity data and the additional keys.

11. An article of manufacture comprising:
a machine-accessible medium including data that, when accessed by a machine, cause the machine to perform operations comprising:
generating a first key;
generating first validity data based on first backup data and the first key;
sending the first key to a peer storing the first backup data; and
requesting second validity data from the peer to determine whether the first backup data is preserved by the peer, wherein the second validity data is based on the first backup data stored by the peer and the first key.

12. The article of manufacture of claim 11, wherein the machine-accessible medium further includes data that cause the machine to perform operations comprising:
penalizing the peer if the second validity data is not timely received from the peer.

13. The article of manufacture of claim 12, wherein the machine-accessible medium further includes data that cause the machine to perform operations comprising:
receiving the second validity data from the peer;
determining whether the first validity data and the second validity data are different; and
penalizing the peer if the first validity data and the second validity data are determined to be different.

14. The article of manufacture of claim 13, wherein the machine-accessible medium further includes data that cause the machine to perform operations comprising:
storing second backup data received from the peer, wherein penalizing the peer comprises deleting the second backup data.

15. The article of manufacture of claim 13, wherein the machine-accessible medium further includes data that cause the machine to perform operations comprising:
providing the peer with consideration for storing first backup data, wherein penalizing the peer comprises recovering at least a portion of the consideration.

16. The article of manufacture of claim 11, wherein the first backup data is encrypted.

17. The article of manufacture of claim 11, wherein generating first validity data comprises:
combining the first key and the first backup data to create first keyed backup data; and
performing a one-way hash function on the first keyed backup data.

18. The article of manufacture of claim 17, wherein the one-way hash function is selected from the group consisting of MD5, SHA-1, and RIPEMD-160.

19. The article of manufacture of claim 11, wherein the machine-accessible medium further includes data that cause the machine to perform operations comprising:
generating a plurality of additional keys;
generating additional validity data for each of the additional keys, wherein each additional validity data is based on the first backup data and one of the additional keys;
sending a selected one of the additional keys to the peer; and
requesting third validity data from the peer to determine whether the first backup data is preserved by the peer, wherein the third validity data is based on the first backup data stored by the peer and the selected one of additional keys.

20. The article of manufacture of claim 19, wherein the method further comprises:
storing the additional validity data and the additional keys.

21. A system for validating first backup data, the system comprising:
a twisted pair cable;
a data storage device;
a key generator to generate a first key;
a validity data generator to generate first validity data based on the first backup data and the first key;
a communication device to send the key to a peer storing the first backup data and to request second validity data from the peer, wherein the second validity data is based on the first backup data stored by the peer and the first key; and
a validity data comparator to determine whether the first backup data is preserved by the peer.

22. The system of claim 21, further comprising:
the communication device to receive the second validity data from the peer; and
a penalty generator to inflict a penalty against the peer if the second validity data is not timely received from the peer.

23. The system of claim 22, further comprising:
the validity data comparator to compare the first validity data and the second validity data; and
the penalty generator to inflict a penalty against the peer if the first validity data and the second validity data do not match.

24. The system of claim 23, wherein the penalty comprises deletion of second backup data received from the peer.

25. The system of claim 23, wherein the penalty comprises recovering a portion of consideration provided to the peer for storing the first backup data.

26. The system of claim 21, wherein the first backup data is encrypted.

27. The system of claim 21, further comprising:
the validity data generator to combine the first key and the first backup data to create first keyed backup data and to perform a one-way hash function on the first keyed backup data.

28. The system of claim 27, wherein the one-way hash function is selected from the group consisting of MD5, SHA-1, and RIPEMD-160.

29. The system of claim 21, further comprising:
the key generator to generate a plurality of additional keys;
the validity data generator to generate additional validity data for each of the additional keys, wherein each additional validity data is based on the first backup data and one of the additional keys;
the communication device to send a selected one of the additional keys to the peer and to request third validity data from the peer; and
the validity data comparator to determine whether the first backup data is preserved by the peer, wherein the third validity data is based on the first backup data stored by the peer and the selected one of additional keys.

30. The system of claim 29, further comprising:
the data storage device to store the additional validity data and the additional keys.
